(19) United States
(12) Patent Application Publication
(10) Pub. No.: US 2009/0092089 A1
(43) Pub. Date: Apr. 9, 2009

(54) Radio Communication Terminal and Data Transmission/Reception Circuit

(75) Inventor: Koki Okada, Kyoto-shi (JP)

Correspondence Address: FISH & RICHARDSON P.C.;Citigroup Center, 52nd Floor, 153 East 53rd Street, New York, NY, 10022-4611, US

(73) Assignee: Rohm Co., Ltd., Kyoto (JP)

(21) Appl. No.: 12/238,551

(22) Filed: Sep. 26, 2008

(30) Foreign Application Priority Data
Sep. 27, 2007 (JP) 2007-251237 (P)

(51) Int. Cl. H04W 88/02

(52) U.S. Cl. 370/329

(57) ABSTRACT

A radio communication terminal includes a transmission/reception unit performing transmission/reception of data, and a channel control unit controlling a communication channel in the transmission/reception unit. The transmission/reception unit is formed of a physical layer protocol processing unit processing a protocol of a physical layer in the transmission/reception of the data. The channel control unit is formed of a medium access control unit controlling a transmission/reception form of the data in a data link layer in the transmission/reception of the data. The channel control unit includes an execution unit executing processing for determining a state of the transmission/reception of the data by the transmission/reception unit, a determination unit determining the transmission/reception state based on a result of the processing by the execution unit, and a switching unit executing processing for switching the communication channel in the transmission/reception unit based on a result of the determination by the determination unit.

### BACKGROUND OF THE INVENTION

1. Field of the Invention

The present invention relates to a radio communication terminal and a data transmission/reception circuit, and particularly to a radio communication terminal and a data transmission/reception circuit that can select an antenna to be used for communications from among a plurality of antennas.

2. Description of the Background Art

In mobile communications, various techniques have been studied for selecting a transmission path that causes less deterioration of characteristics of received signals due to interference waves or fast fading, for the purpose of improving communications performance.

For example, an antenna-switchable diversity system is one of such techniques. In this system, a radio communication terminal used for mobile communications is provided with a plurality of antennas each receiving signals transmitted via a plurality of different transmission paths, and an antenna receiving the signal at the highest reception level in a branch of the received signal is selected. When the reception level of this antenna lowers to a certain threshold or below, antenna switching is performed to select another antenna having the reception level of the threshold level or more.

Various techniques have already been disclosed for the above diversity system. For example, a publication (Japanese Patent Laying-Open No. 2007-143090) has disclosed a technique selecting one antenna from among a plurality of antennas, using packets that are included in received packets and are determined as packets to other destination addresses. More specifically, as shown in its FIG. 6, this publication has disclosed the technique that calculates a discrete degree of a spectral power for each sub-carrier of the packet received by each antenna, and selects the antenna of the smallest discrete degree.

Reduction of hardware in the terminal can reduce the cost, and therefore has always been desired. Particularly, it is considered that reduction of hardware in a radio communication terminal used for mobile communications is highly desired because it leads to reduction of electric power consumption and others.

However, it is not preferable that mere reduction of hardware significantly impairs the communication performance.

### SUMMARY OF THE INVENTION

The invention has been made in view of the above matters, and an object of the invention is to provide a radio communication terminal and a data transmission/reception circuit for use in the radio communication terminal, and particularly to reduce required hardware resources while keeping communication performance.

A radio communication terminal of the invention includes a transmission/reception unit performing transmission/reception of data, and a channel control unit controlling a communication channel in the transmission/reception unit. The transmission/reception unit is formed of a physical layer protocol processing unit processing a protocol of a physical layer in the transmission/reception of the data. The channel control unit is formed of a medium access control unit controlling a transmission/reception form of the data in a data link layer in the transmission/reception of the data. The channel control unit includes an execution unit executing processing for determining a state of the transmission/reception of the data by the transmission/reception unit, a determination unit determining the transmission/reception state based on a result of the processing by the execution unit, and a switching unit executing processing for switching the communication channel in the transmission/reception unit based on a result of the determination by the determination unit.

A data transmission/reception circuit of the invention is mounted on a radio communication terminal. The data transmission/reception circuit includes a transmission/reception unit performing transmission/reception of data, and a channel control unit controlling a communication channel in the transmission/reception unit. The channel control unit includes an execution unit executing processing for determining a state of transmission/reception of the data by the transmission/reception unit, a determination unit determining the transmission/reception state based on a result of the processing by the execution unit, and a switching unit executing processing for switching the communication channel in the transmission/reception unit based on a result of the determination by the determination unit.

In the data transmission/reception by the radio communication terminal according to the invention, the state of the transmission/reception is determined not by the physical layer protocol processing unit but by the medium access unit. In the radio communication terminal, it is determined, based on the result of this determination, whether the communication channel in the data transmission/reception is to be switched or not.

Thereby, the communication channel can be switched according to the state of data transmission/reception in the radio communication terminal without employing special hardware controlled by the physical layer protocol processing unit.

According to the invention, therefore, the radio communication terminal and the data transmission/reception circuit used in the terminal appropriately switches the communication channel, and thereby can reduce a required hardware resource while holding communication performance.

Further, the determination about the state of the data transmission/reception by the medium access unit can significantly reduce the quantity of handled data, as compared with the determination by the physical layer protocol processing unit.

According to the invention, therefore, the effect of reducing the processing time and the power consumption can be achieved owing to the reduction in quantity of the handled data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a hardware structure of a radio communication terminal of an embodiment of the invention.

FIG. 2 is a flowchart of packet reception processing executed by a control MAC (Media Access Control) unit in FIG. 1.

FIG. 3 is a flowchart of a packet transmission processing executed by the control MAC unit in FIG. 1.

### DESCRIPTION OF THE PREFERRED EMBODIMENTS

An embodiment of a radio communication terminal of the invention will be described below with reference to the drawings.

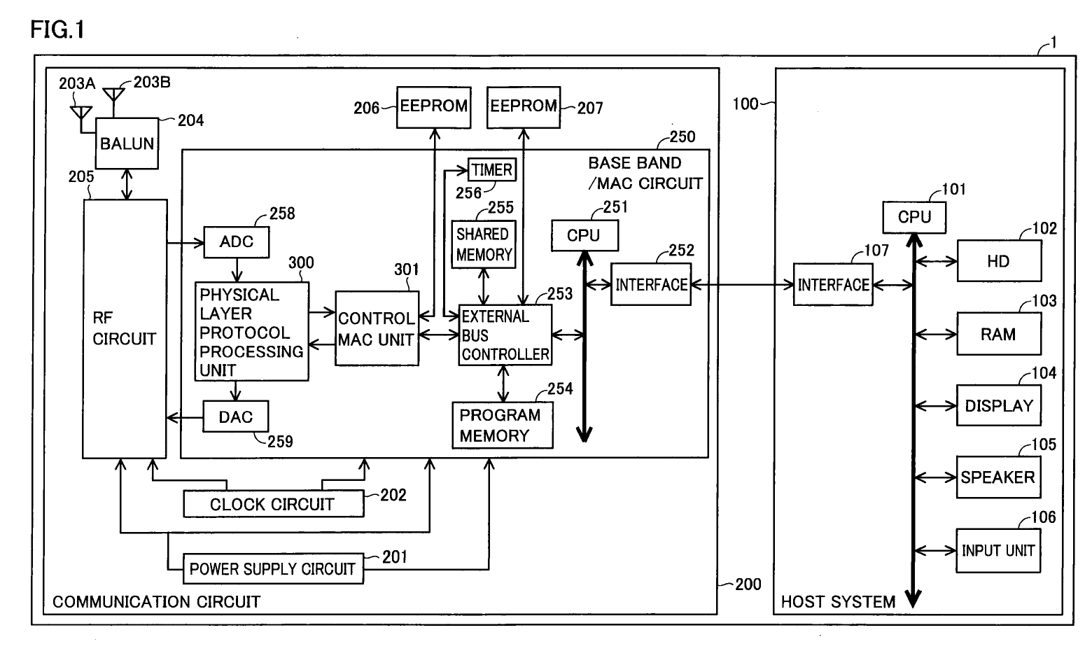

Referring to FIG. 1, a terminal 1 primarily includes a host system 100 for execution of applications and others, and a communication circuit 200 transmitting and receiving data and the like used by applications. Communication circuit 200 is formed of, e.g., a dedicated LSI (Large Scale Integration) and is implemented in terminal 1.

Host system 100 includes a CPU (Central Processing Unit) 101 controlling a whole operation of host system 100.

An HD (Hard disk) 102 stores programs of various applications executed by host system 100. Host system 100 includes a RAM (Random Access Memory) 103 providing a work area of CPU 101, a display 104 displaying information, a speaker 105 outputting sounds, an input unit 106 such as keys and buttons for externally entering information and an interface 107 transmitting information (data) to and from communication circuit 200.

Communication circuit 200 includes a base band/MAC circuit 250, an RF (Radio Frequency) circuit 205, a balun 204, antennas 203A and 203B, EEPROMs (Electrically Erasable and Programmable Read Only Memories) 206 and 207, a power supply circuit 201 and a clock circuit 202.

Clock circuit 202 supplies a clock signal to baseband/MAC circuit 250 and RF circuit 205. Power supply circuit 201 controls the power supply to baseband/MAC circuit 250 and RF circuit 205.

RF circuit 205 transmits and receives the data via antenna 203A or 203B. Balun 204 is arranged between antennas 203A and 203B and RF circuit 205.

Baseband/MAC circuit 250 includes a CPU 251, an interface 252, an external bus controller 253, a program memory 254, a shared memory 255, a timer 256, a physical layer protocol processing unit 300, a controller MAC unit 301, an ADC (Analog-Digital Converter) 258 and a DAC (Digital-Analog Converter) 259.

Physical layer protocol processing unit 300 corresponds to a first layer of an OSI (Open Systems Interconnection) reference model, and performs processing such as physical connection to a network and the like. Control MAC unit 301 corresponds to a lower sub-layer of a second layer of the OSI reference model, and executes error detection on received data (frame) and the like.

Interface 252 is employed for host system 100. When CPU 251 receives an instruction to transmit the data to the network from host system 100, CPU 251 causes interface 252 to take out the instructed data that is stored in the memory (e.g., RAM 103) of host system 100. Host system 100 produces data of which transmission is instructed, stores the produced data in the above memory and then transmits the transmission instruction for this data to communication circuit 200. The data taken out by interface 252 is temporarily stored in program memory 254 as data forming a “user data body” of the frame to be transmitted to the network.

CPU 251 produces the frame to be transmitted to the network by adding various kinds of data including a MAC header and an FCS (Frame Check Sequence) to the data stored in program memory 254, stores the produced frame in program memory 254 and sets a flag in shared memory 255 to the effect that the frame has been produced.

Communication circuit 200 receives the data transmitted over the network as described below.

The frame sent to RF circuit 205 via antennas 203A and 203B and balun 204 is converted by ADC 258 into digital data, and the data (serial data) thus converted is converted by physical layer protocol processing unit 300 into parallel data. The converted data is sent to control MAC unit 301.

Control MAC unit 301 performs frame top detection as well as time and frequency synchronization processing on the frame converted into the digital signal, and then performs error correction decoding on it. Control MAC unit 301 can select a channel (physical channel) to be used for transmission/reception of the data via RF circuit 205. Further, control MAC unit 301 determines whether a destination address (DA) of the frame in question matches a MAC address of communication circuit 200 in question stored in EEPROM 206 or not. When it is determined that they match together, the MAC header and FCS are removed from the frame, and then the remaining data (frame body) is transferred to program memory 254. When they do not match together, control MAC unit 301 abandons the received frame.

When the received frame body is stored in program memory 254, control MAC unit 301 sets a flag representing it in shared memory 255. In response to the setting of this flag, CPU 251 sends a frame body portion 320 stored in program memory 254 to host system 100 via interface 252.

The data that is sent from host system 100 and is stored in program memory 254 is processed by control MAC unit 301 to add data such as a long training signal and the like to it, and then is converted by physical layer protocol processing unit 300 into serial data. Further, the data is converted into analog data by DAC 259, and then is sent to the network via antenna 203A or 203B.

In terminal 1, the data transmission/reception is performed via one of two antennas 203A and 203B employed in terminal 1, control MAC unit 301 performs the processing on the data to be transmitted or received for determining the state of transmission/reception of data in terminal 1. Control MAC unit 301 determines the state of the data transmission/reception in terminal 1 based on a result of the above processing, and executes processing based on a result of this determination to switch the antenna to be used for the data transmission/reception in terminal 1 from the above one to the other of the two antennas.

In terminal 1, control MAC unit 301 controls physical layer protocol processing unit 300 and particularly the channel (the physical channel or the communication channel) to be used for the data transmission/reception via RF circuit 205. More specifically, control MAC unit 301 performs the processing on the data to be transmitted/received via RF circuit for determining the state of data transmission/reception in terminal 1. Control MAC unit 301 determines the state of the data transmission/reception in terminal 1 based on the result of this processing, and successively selects, based on a result of this determination, the communication channel to be used for the data transmission/reception in terminal 1 from among the communication channels corresponding in number to the communication system or method employed in terminal 1. For example, in the IEEE (Institute of Electrical and Electronic Engineers) method, the communication channel is successively selected from among 14 communication channels.

Description will now be given on processing executed by control MAC unit 301 for selecting or switching the communication channel as described above.

Control MAC unit 301 can perform the processing in question for receiving data (packets), for transmitting data or for transmitting and receiving data. Accordingly, description will first be given on the case where control MAC unit 301 executes the processing in question for receiving the data.

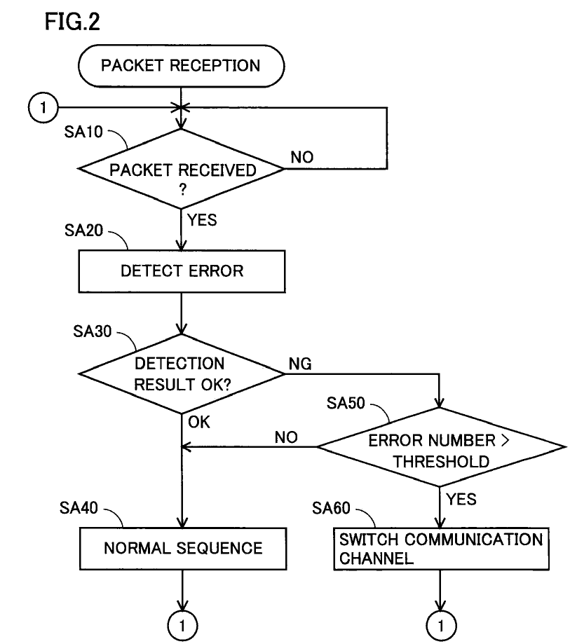

FIG. 2 is a flowchart of processing (packet reception processing) executed by control MAC unit 301 for receiving the packet by terminal 1.

Referring to FIG. 2, the packet reception processing is first performed in step SA10 to determine whether physical layer protocol processing unit 300 has received a packet or not. When it has received the packet, the process proceeds to step SA20.

In step SA20, error detection is performed on the packet of which reception is determined in step SA10 and which is transmitted from physical layer protocol processing unit 300. Then, the process proceeds to step SA30.

The manner of error detection in step SA20 depends on a data format of the transmitted packet, but the error detection is preferably performed using a frame check sequence, in view of improvement of data transmission efficiency on the network over which terminal 1 transmits or receives the data. However, the error detection in the invention is not restricted to the above manner.

In step SA30, it is determined whether the error detection in step SA20 has detected a bit error in the received packet or not (i.e., whether the detection result is NG or OK). When it is determined that the bit error is present (i.e., the detection result is NG), the process proceeds to step SA50. When no bit error is present (i.e., the detection result is OK), the process proceeds to step SA40.

In step SA40, an ordinary sequence for the packet reception is executed, and then the processing ends. The processing contents of the ordinary sequence for the packet reception are the same as those performed on a general MAC layer such as MAC address checking on the received packet.

In step SA50, it is determined whether the number of bit errors detected by the error detection in step SA20 exceeds a predetermined threshold or not. When it exceeds the threshold, the process proceeds to step SA60. When it does not exceed the threshold, the process proceeds to step SA40.

In step SA60, processing is performed to switch the communication channel to be used for the data transmission/reception, and the process returns to step SA10.

The switching of the communication channel is performed by employing a well-known technique. For example, in the IEEE 802.11g system, the channel is switched among 14 channels, e.g., such that the currently used channel 1 changes to channel 2, or the currently used channel 2 changes to channel 2. For switching the channel without causing overlapping of the current and new frequency bands, the switching of the communication channel may be performed, e.g., such that the currently used channel 1 changes to channel 6, the currently used channel 6 changes to channel 11, or the currently used channel 11 changes to channel 2.

According to the packet reception processing described above, the error detection is performed on the packet received in terminal 1, and it is determined, based on the result of this error detection, whether it is necessary in terminal 1 to switch the communication channel used for the data transmission/reception or not. When it is determined that the switching is necessary, the processing is executed on physical layer protocol processing unit 300 to switch the antenna used for the data transmission/reception.

In the packet reception processing described above, the determination in step SA50 allows determination whether the switching of the communication channel used for the data transmission/reception is required or not, without performing processing of a relatively large data processing quantity such as conventionally required determination of reception intensity for each frequency of the received data.

According to the packet reception processing described above, even in the case where the received packet contains a bit error, the communication channel is not switched unless the number of such bit errors exceeds a threshold. In this embodiment, it is merely required to switch the communication channel according to at least the number of the bit error(s), and the embodiment may be configured to switch the antenna when the number of bit error in the received packet is one (and thus when it is determined at least that a bit error is present, without performing the determination using the threshold, e.g., in step SA50). Conversely, such a configuration may be employed that the channel witching is not preformed only when the number of bit error(s) exceeds the threshold only one time, and the communication channel is switched only when the state where the number exceeds the threshold occurs a predetermined number of times.

Then, description will be given on an example in which the switching of the communication channel is performed for the data transmission from terminal 1.

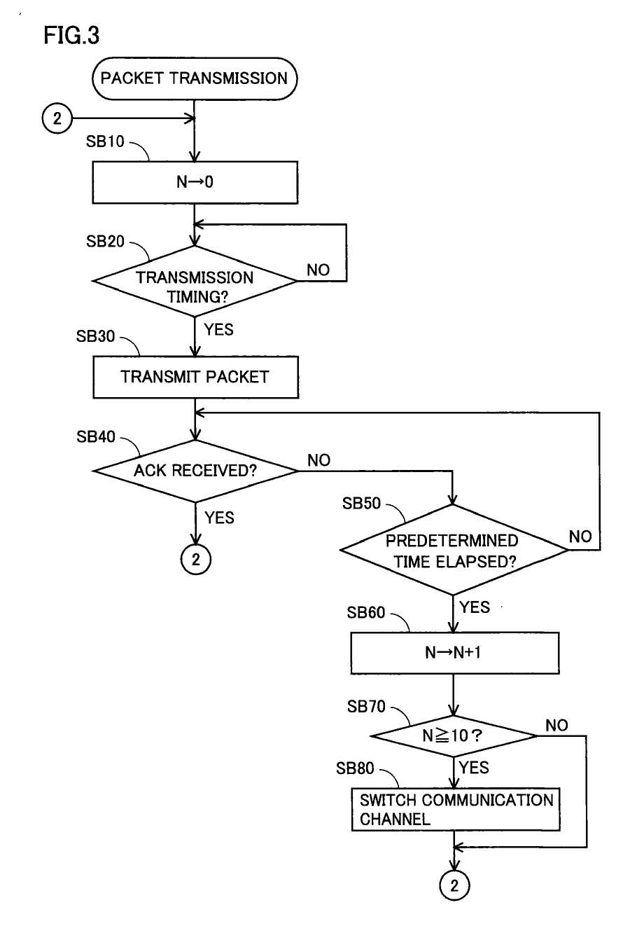

FIG. 3 is a flowchart of processing (packet transmission processing) that is executed by control MAC unit 301 for transmitting the packet from terminal 1.

Referring to FIG. 3, in the packet transmission processing, control MAC unit 301 first sets a value of a variable N to 0 in step SB10, and then the process proceeds to step SB20. It is noted that variable N is appropriately referred to and updated in the packet transmission processing.

In step SB20, it is determined with respect to timing whether the data transmission from communication circuit 200 is to be performed or not. Communication circuit 200 is configured to transmit a beacon signal at constant time intervals in addition to data corresponding to a data transmission request from host system 100. CPU 251 manages the timing for such transmission of the beacon signal based on a general technology.

When it is determined in step SB20 with respect to the timing that the data is to be transmitted, the process proceeds to step SB30.

In step SB30, the processing of transmitting the packet to the network via antenna 203A or 203B is executed according to the general technology, and the process proceeds to step SB40.

In step SB40, it is determined whether an ACK (Acknowledgement) signal was received or not. When it was received, the process returns to step SB10. When it was not received, the process proceeds to step SB50. The ACK signal means a signal transmitted from a different terminal for informing that this different terminal has received the packet sent thereto in step SB30.

In step SB50, it is determined whether a predetermined time has elapsed after the packet is transmitted in step SB30, or not. When the time has not elapsed, the process returns to step SB40. When the time has elapsed, the process proceeds to step SB60.

By processing in step SB60, variable N is incremented by one, and the process proceeds to step SB70.

In step SB70, it is determined whether variable N takes a value of 10 or more, or not. When it is smaller than 10, the process returns to step SB10. When it is determined in step SB70 that variable N takes a value of 10 or more, the process proceeds to step SB80.

In step SB80, processing is performed for switching the communication channel to be used for the data transmission/reception, similarly to step SA60 already described, and the process returns to step SB10.

The packet transmission processing already described detects a form of occurrence of abnormality when communication circuit 200 transmits the packet according to a request by host system 100 or according to beacon signal transmission managed by CPU 251, and determines whether the form of the abnormality occurrence requires the switching of the communication channel or not. When it is determined that the switching is required, the processing for switching the communication channel is executed.

More specifically, the processing manages the value of variable N indicating the number of times which abnormality occurred during the data transmission, and thereby detects the form or manner of the abnormality occurrence during the data transmission. It is noted that the abnormality during the data transmission represents such a fact that the ACK signal for a transmitted packet could not be received before a predetermined time elapses after this packet was transmitted.

The form of the abnormality occurrence is detected, i.e., when variable N representing the number of times which the transmission abnormality occurred takes the value of 10 or more, it is determined that the. switching of the communication channel is required. When it is determined that the switching of the communication channel is required, the processing for switching the communication channel is executed in step SB80.

The value of N representing the conditions for communication channel switching in the data transmission processing is not restricted to 10. For example, in a system requiring relatively high data transmission efficiency, N may be set to a smaller value. The conditions for determining the occurrence of the abnormality during the data transmission are not restricted to the foregoing fact that the ACK signal cannot be received during a predetermined time after the data transmission. The foregoing “predetermined time” may be variable according to a throughput of the network.

According to the packet transmission processing described above, when the processing in steps SB40-SB80 is performed, the system can determine whether the communication channel used for the data transmission/reception is to be switched or not, without performing the conventionally required processing of a relatively large data processing quantity such as determination of reception intensity for each frequency of the received data.

In the embodiment already described, the processing executed by control MAC unit 301 is practically is implemented, e.g., by CPU 251 that executes processing corresponding to the MAC layer (a lower sub-layer of a data link layer (second layer) of an OSI reference model).

In the embodiment already described, it is merely required in terminal 1 to perform the processing of switching the communication channel in at least one of the data reception processing and the data transmission processing. Naturally, for switching the communication channel more appropriately, the processing of switching the communication channel may be performed in both the data reception processing and data transmission processing.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A radio communication terminal, comprising:
a transmission/reception unit performing transmission/reception of data; and
a channel control unit controlling a communication channel in said transmission/reception unit, wherein
said transmission/reception unit is formed of a physical layer protocol processing unit processing a protocol of a physical layer in the transmission/reception of the data,
said channel control unit is formed of a medium access control unit controlling a transmission/reception form of the data in a data link layer in the transmission/reception of the data, and
said channel control unit includes an execution unit executing processing for determining a state of the transmission/reception of the data by said transmission/reception unit, a determination unit determining said transmission/reception state based on a result of the processing by said execution unit, and a switching unit executing processing for switching the communication channel in said transmission/reception unit based on a result of the determination by said determination unit.

2. The radio communication terminal according to claim 1, wherein
said execution unit executes detection of an error on the data received by said transmission/reception unit,
said determination unit determines whether a number of bit errors detected in said error detection is equal to or larger than a predetermined threshold or not, and
said switching unit executes the processing for switching the communication channel when said determination unit determines that the number of the bit errors detected by said error detection is equal to or larger than said predetermined threshold.

3. The radio communication terminal according to claim 2, wherein
said error detection is error detection using a frame check sequence.

4. The radio communication terminal according to claim 1, wherein
said execution unit executes processing of detecting an occurrence form of abnormality in the processing of transmitting the data by said transmission/reception unit,
said determination unit determines whether the abnormality occurrence form detected by said execution unit is a form requiring the switching of the communication channel or not, and
said switching unit executes the processing for switching the communication channel when the abnormality occurrence form detected by said execution unit is a form requiring the switching of the communication channel.

5. The radio communication terminal according to claim 4, wherein
said execution unit detects that the abnormality occurred in the processing of transmitting the data by said transmission/reception unit, when said execution unit detects that the an ACK (Acknowledgement) signal was not received before a predetermined time elapses after said transmission/reception unit transmitted the data, and
said determination unit determines that the form requires the switching of the communication channel, when said execution unit determines that the abnormality occurred a predetermined number of times or more in the processing of transmitting the data by said transmission/reception unit.

6. A data transmission/reception circuit mounted on a radio communication terminal, comprising:
a transmission/reception unit performing transmission/reception of data; and
a channel control unit controlling a communication channel in said transmission/reception unit, wherein
said channel control unit includes:
an execution unit executing processing for determining a state of transmission/reception of the data by said transmission/reception unit,
a determination unit determining said transmission/reception state based on a result of the processing by said execution unit, and
a switching unit executing processing for switching the communication channel in said transmission/reception unit based on a result of the determination by said determination unit.

7. The data transmission/reception circuit according to claim 6, wherein
said execution unit executes detection of an error on the data received by said transmission/reception unit,
said determination unit determines whether a number of bit errors detected in said error detection is equal to or larger than a predetermined threshold or not, and
said switching unit executes the processing for switching the communication channel when said determination unit determines that the number of the bit errors detected by said error detection is equal to or larger than said predetermined threshold.

8. The data transmission/reception circuit according to claim 7, wherein
said error detection is error detection using a frame check sequence.

9. The data transmission/reception circuit according to claim 6, wherein
said execution unit executes processing of detecting an occurrence form of abnormality in the processing of transmitting the data by said transmission/reception unit,
said determination unit determines whether the abnormality occurrence form detected by said execution unit is a form requiring the switching of the communication channel or not, and
said switching unit executes the processing for switching the communication channel when the abnormality occurrence form detected by said execution unit is a form requiring the switching of the communication channel.

10. The data transmission/reception circuit according to claim 9, wherein
said execution unit detects that the abnormality occurred in the processing of transmitting the data by said transmission/reception unit, when said execution unit detects that the an ACK (Acknowledgement) signal was not received before a predetermined time elapses after said transmission/reception unit transmitted the data, and
said determination unit determines that the form requires the switching of the communication channel, when said execution unit determines that the abnormality occurred a predetermined number of times or more in the processing of transmitting the data by said transmission/reception unit.
